(19) United States
(12) Patent Application Publication
(10) Pub. No.: US 2022/0267195 A1
(43) Pub. Date: Aug. 25, 2022

(54) ANTIGLARE SURFACE WITH ULTRA-LOW SPARKLE AND THE METHOD OF MAKING THE SAME

(71) Applicant: CORNING INCORPORATED, CORNING, NY (US)

(72) Inventors: Haixing Chen, Shanghai (CN); Ling Chen, Shanghai (CN); Jiangwei Feng, Painted Post, NY (US); Yuhui Jin, Painted Post, NY (US); Jianqiang Zhu, Shanghai (CN)

(21) Appl. No.: 17/626,223

(22) PCT Filed: Jul. 6, 2020
(86) PCT No.: PCT/US2020/040877

§ 371 Date: Jan. 11, 2022

Related U.S. Application Data
(60) Provisional application No. 62/873,554, filed on Jul. 12, 2019.

(51) Int. Cl. C03C 15/00; C03C 23/00; C03C 21/00; C09K 13/06

(52) U.S. Cl. CPC C03C 15/00; C03C 23/0075; C03C 21/002; C09K 13/06; C03C 2204/08

(57) ABSTRACT

The present disclosure includes a method of making an article including etching a surface of a substrate with an etching suspension comprising an etching cream and glycerin, such that the surface is an anti-glare surface and the article comprises a sparkle of no more than 1%. An article made by the method can include a substrate having a textured surface and comprises a sparkle of no more than 1%.

### CROSS-REFERENCE TO RELATED APPLICATIONS

This application claims the benefit of priority under 35 U.S.C. § 119 of U.S. Provisional Application Ser. No. 62/873,554 filed on Jul. 12, 2019 the content of which is relied upon and incorporated herein by reference in its entirety.

### BACKGROUND

Chemically strengthened glass is used on more than five billion devices as a user interface for touch screens. These devices include handheld devices and automotive displays, among other consumer products. For automotive displays, optical clarity and strength with thinner aspect ratios are important for fuel economy and low weight.

Generally, these types of glass are treated for both aesthetics and functional purposes. For example, anti-reflective, anti-glare, and anti-fingerprint coatings or treatments are often applied. In the context of automotive applications, these coatings must last longer than on consumer electronics.

Anti-glare (AG) glasses are used widely for glass displays where external light might be reflected off the surface of the glass, particularly in bright sunlight or high ambient lighting conditions. When light is reflected of the glass surface, readability of the display is improved where an anti-glare treatment is applied. AG treatments additionally reduce the “ghost” effect of reflected images that can distract the consumer interacting with the glass display.

AG treatments generally use diffusion mechanisms to break up reflected light on the surface of the glass. Diffusion works by reducing the coherence of reflected images, making unwanted images unfocused to the eye and reducing those images' interference with the intended image on the display. However, diffusion mechanisms can sacrifice clarity and resolution of the intended image. Thus, the AG treatment can affect the quality of the intended image on the glass display. AG treatments such as chemically or mechanically texturing the surface of the glass can reduce glare, but also reduce the intended image resolution and induce distracting sparkle on the glass surface which interferes with the intended image readability.

### SUMMARY OF THE DISCLOSURE

The disclosure provides a method of making an article including etching a surface of a substrate with an etching suspension comprising an etching cream and glycerin, wherein the resulting surface imparts anti-glare properties to the article. The resulting surface may be described herein as an anti-glare surface. In one or more embodiments, anti-glare surface is an etched surface and the article exhibits or comprises a sparkle of no more than 1%. The glycerin allows for the ultra-low sparkle on the article surface.

The disclosure provides an article including a substrate having a textured surface and comprising a sparkle of no more than 1%.

The methods and articles disclosed herein can provide a textured glass with ultra-low sparkle of less than 1% and anti-glare properties and an etched or anti-glare glass surface with uniform appearance. For example, the ultra-low sparkle can be consistent across the surface of the substrate.

The methods disclosed herein do not affect the mechanical properties of the glass substrate, for example, the glass substrate can maintain its strength after undergoing anti-glare treatment producing ultra-low sparkle.

The methods and articles disclosed herein can provide easy tailoring of anti-glare properties of a textured glass substrate by manipulating time and chemical concentration of an etching process.

In some embodiments, the methods and articles disclosed herein can be low cost and easily scalable.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1. is a 3-D topography map of an ultra-low sparkle textured glass substrate, in accordance with various embodiments.

FIG. 2. is a graphical representation of a correlation of transmission haze and feature size for ultra-low sparkle textured glass substrates, in accordance with various embodiments.

FIG. 3. is a graphical representation of a relationship among transmission haze, sparkle and Gloss@60 degree for ultra-low sparkle textured glass substrate, in accordance with various embodiments.

FIG. 4. is a graphical representation of a correlation of Gloss@60 degree, DOI and Sparkle for ultra-low sparkle textured glass substrates, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

### Overview

Glass substrates used in displays generally require anti-glare (AG) treatments for clarity of the intended image. However, AG treated glass substrates can have higher sparkle and lower resolution of the intended image compared to non-treated glasses. Currently lower sparkle (2-3% sparkle) AG glasses still interfere with high resolution images on glass displays, particularly where the image resolution is higher than 220 pixels per inch (PPI).

An ultra-low sparkle (no more than 1%) AG glass surface could provide the appropriate diffusion effect to reduce reflection on internal and external lighting on the glass display but maintain image clarity. Thus, ultra-low sparkle AG glass surfaces, with a sparkle of no more than 1%, are desired.

Discussed herein is a method of making articles with an anti-glare surface on a substrate, such as aluminosilicate glass substrates. The articles according to one or more embodiments exhibit a low sparkle and uniformity in terms of a textured surface and optical performance, and the resulting glass articles. In various embodiments, the method includes adding glycerin, to an etching cream to create an etching suspension. The substrate surface is etched with substantial uniformity to produce a low sparkle (e.g., less than 1%) surface, without impacting. The process does not impact the mechanical performance of the substrate and is scalable.

The article discussed herein produced by this method can have, for example, a textured surface with a feature size lower than 5 μm and a roughness ranging from about 20 nm to about 70 nm, corresponding with differing haze levels. The articles can additionally have a transmitted haze from about 2% to about 12%, a gloss at 60° from about 70 gloss units (GU) to about 130 GU, and a distinctness of image (DOI) lower than 99.6. The textured surface of substrate can be, for example, covered with concave shape features possessing narrow distribution. These features allow the glass substrate surface to have good AG and ultra-low sparkle characteristics.

### Substrate

Embodiments of the article use various glass substrates. For instance, where the glass substrate can be formed using known forming methods include float glass processes and down-draw processes such as fusion draw and slot draw. In some embodiments, the glass substrate can be formed from a “phase-separable” glass composition which may undergo phase separation into two or more distinct phases upon exposure to a phase separation treatment, such as a heat treatment or the like, to produce a “phase separated” glass including distinct glass phases having different compositions.

A glass substrate prepared by a float glass process can be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

Down-draw processes produce glass substrates having a uniform thickness that possess relatively pristine surfaces. Because the average flexural strength of glass substrates is controlled by the amount and size of surface flaws, a pristine surface that has had minimal contact has a higher initial strength. When this high strength glass substrate is then further strengthened (e.g., chemically or thermally), the resultant strength can be higher than that of a glass substrate with a surface that has been lapped and polished. Down-drawn glass substrates can be drawn to a thickness of less than about 2 mm In addition, down drawn glass substrates have a very flat, smooth surface that can be used in its final application without additional grinding and polishing steps.

The glass substrate can be formed using a fusion draw process, for example, which uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous material and into an annealing region.

In some embodiments, the compositions used for the glass substrate making up the glass substrate can be batched with about 0 mol % to about 2 mol. % of at least one fining agent selected from a group that includes Na₂SO₄, NaCl, NaF, NaBr, K₂SO₄, KC₁, KF, KBr, and SnO₂.

Once formed, the glass substrate can be strengthened to form a strengthened glass substrate. It should be noted that glass-ceramics described herein may also be strengthened in the same manner as glass substrates. As used herein, the term “strengthened material” generally refers to a glass substrate or a glass-ceramic material that has been chemically strengthened, for example through ion-exchange of larger ions for smaller ions in the surface of the glass or glass-ceramic material. However, other strengthening methods known in the art, such as thermal tempering, can be utilized to form strengthened glass substrates and/or glass-ceramic materials. In some embodiments, the materials can be strengthened using a combination of chemical strengthening processes and thermally strengthening processes.

The strengthened materials described herein can be chemically strengthened by an ion exchange process. In the ion-exchange process, typically by immersion of a glass or glass-ceramic material into a molten salt bath for a predetermined period of time, ions at or near the surface(s) of the glass or glass-ceramic material are exchanged for larger metal ions from the salt bath. In one embodiment, the temperature of the molten salt bath is in the range from about 400° C. to about 430° C. and the predetermined time period is about four to about twenty-four hours; however, the temperature and duration of immersion may vary according to the composition of the material and the desired strength attributes. The incorporation of the larger ions into the glass or glass-ceramic material strengthens the material by creating a compressive stress in a near surface region or in regions at and adjacent to the surface(s) of the material. A corresponding tensile stress is induced within a central region or regions at a distance from the surface(s) of the material to balance the compressive stress. Glass or glass-ceramic materials utilizing this strengthening process can be described more specifically as chemically-strengthened or ion-exchanged glass or glass-ceramic materials.

In one example, sodium ions in a strengthened glass or glass-ceramic material are replaced by potassium ions from the molten bath, such as a potassium nitrate salt bath, though other alkali metal ions having larger atomic radii, such as rubidium or cesium, can replace smaller alkali metal ions in the glass. According to particular embodiments, smaller alkali metal ions in the glass or glass-ceramic can be replaced by Ag+ ions. Similarly, other alkali metal salts such as, but not limited to, sulfates, phosphates, halides, and the like can be used in the ion exchange process.

The replacement of smaller ions by larger ions at a temperature below that at which the glass network can relax produces a distribution of ions across the surface(s) of the strengthened material that results in a stress profile. The larger volume of the incoming ion produces a compressive stress (CS) on the surface and tension (central tension, or CT) in the center of the strengthened material. The compressive stress is related to the central tension by the following relationship:

$$CS = CT ( \frac{t - 2 DOL}{DOL} )$$

where it is the total thickness of the strengthened glass or glass-ceramic material and compressive depth of layer (DOL) is the depth of exchange. Depth of exchange can be described as the depth within the strengthened glass or glass-ceramic material (i.e., the distance from a surface of the glass substrate to a central region of the glass or glass-ceramic material), at which ion exchange facilitated by the ion exchange process takes place.

In one embodiment, a strengthened glass or glass-ceramic material can have a surface compressive stress of about 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. The strengthened glass or glass-ceramic material may have a compressive depth of layer about 15 μm or greater, 20 μm or greater (e.g., 25 μm, 30 μm, 35 μm, 40 μm, 45 μm, 50 μm or greater) and/or a central tension of about 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened glass or glass-ceramic material has one or more of the following: a surface compressive stress greater than about 200 MPa, a depth of compressive layer greater than about 15 μm, and a central tension greater than about 18 MPa. In one or more embodiments, the \one or both the first substrate and the second substrate is strengthened, as described herein. In some instances, both the first substrate and the second substrate are strengthened. The first substrate can be chemically strengthened, while the second substrate is thermally strengthened. In some instances, only one of the first substrate and the second substrate are chemically and/or thermally strengthened, while the other is not strengthened.

Any number of glass compositions can be employed in the glass substrate and include alkali aluminosilicate glass compositions or alkali aluminoborosilicate glass compositions, though other glass compositions are contemplated. Such glass compositions may be characterized as ion exchangeable. As used herein, “ion exchangeable” means that a material comprising the composition is capable of exchanging cations located at or near the surface of the material with cations of the same valence that are either larger or smaller in size.

For example, a suitable glass composition comprises SiO₂, B₂O₃ and Na₂O, where (SiO₂+B₂O₃)≥66 mol. %, and Na₂O≥9 mol. %. In an embodiment, the glass sheets include at least 6 wt. % aluminum oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)<10 mol. %.

A still further example glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio:

(Al2O₃+B₂O₃)/Σ modifiers>1

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio:

(Al₂O₃+B₂O₃)/Σ modifiers>1

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %<Li₂O+Na₂O+K₂O≤20 mol. % and 0 mol. %≤MgO+CaO≤10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)≤Al₂O₃≤2 mol. %; 2 mol. %≤Na₂O ≤Al₂O₃≤6 mol. %; and 4 mol. %≤(Na₂O+K₂O)≤Al₂O₃≤10 mol. %. Additional examples for generating ion exchangeable glass structures are described in Published U.S. Appl. No. US 2014-0087193 A1 and U.S. Pat. No. 9,387,651 the entirety of each being incorporated herein by reference.

In an alternative embodiment, the glass substrate comprises an alkali aluminosilicate glass composition comprising: 2 mol % or more of Al₂O₃ and/or ZrO₂, or 4 mol % or more of Al₂O₃ and/or ZrO₂.

In some embodiments, the glass substrate comprises a glass-ceramic material that can be fusion-formed or formed by other known methods such as rolling, thin-rolling, slot draw or float.

Glass-ceramics that can be used in various embodiments can be characterized by the processes by which they can be formed. Such glass-ceramics can be formed by float processes, fusion processes, slot draw process, thin rolling processes, or a combination thereof. Some glass-ceramics tend to have liquid viscosities that preclude the use of high throughput forming methods such as float, slot draw, or fusion draw. For example, some known glass-ceramics are formed from precursor glasses having liquidus viscosities of about 10 kP, which are not suitable for fusion draw, where liquidus viscosities of above about 100 kP or above about 200 kP are generally required. Glass-ceramics formed by the low throughput forming methods (e.g., thin rolling) may exhibit enhanced opacity, various degrees of translucency, and/or surface luster. Glass-ceramics formed by high throughout methods (e.g., float, slot draw, or fusion draw) can achieve very thin layers. Glass-ceramics formed by fusion draw methods may achieve pristine surfaces and thinness (e.g., about 2 mm or less). Examples of suitable glass-ceramics can include Li₂O—Al₂O₃—SiO₂ system (i.e. LAS-System) glass-ceramics, MgO—Al₂O₃—SiO₂ system (i.e. MAS-System) glass-ceramics, glass-ceramics including crystalline phases of any one or more of mullite, spinel, a-quartz, β-quartz solid solution, petalite, lithium disilicate, β-spodumene, nepheline, and alumina, and combinations thereof.

In one or more embodiments, one or both the first and second substrate comprise a thickness of about 3 mm or less. In some instances, one of the first and the second substrate has a thickness of about 1 mm to about 3 mm (e.g., from about 1 mm to about 2.8 mm, from about 1 mm to about 2.6 mm, from about 1 mm to about 2.5 mm, from about 1 mm to about 2.4 mm, from about 1 mm to about 2.1 mm, from about 1 mm to about 2 mm, from about 1 mm to about 1.8 mm, from about 1 mm to about 1.6 mm, from about 1 mm to about 1.4 mm, from about 1.2 mm to about 3 mm, from about 1.4 mm to about 3 mm, from about 1.6 mm to about 3 mm, or from about 1.8 mm to about 3 mm), and the other of the first and the second substrate has a thickness of less than 1 mm (e.g., about 0.9 mm or less, about 0.8 mm or less, about 0.7 mm or less, about 0.5 mm or less, about 0.55 mm or less, about 0.4 mm or less, about 0.3 mm or less, or about 0.2 mm or less). The combination of thicknesses for the first substrate and the second substrate can include but are not limited to 2.1 mm/0.7 mm, 2.1 mm/0.5 mm, 1.8 mm/0.7 mm, 1.8 mm/0.5 mm, 1.6 mm/0.5 mm, 1 mm/0.7 mm, and 1 mm/0.5 mm

The glass substrates of the disclosure generally have a stiffness of at least above 90 N/mm, above about 95 N/mm, above about 99 N/mm; from about 90 N/mm to about 100 N/mm, about 95 N/mm to about 100 N/mm, or about 97 N/mm to about 100 N/mm as determined using a ball on ring method for determining stiffness at a rate of deformation of 0.0017 mm/sec.

In one or more embodiments, the glass substrate can have a complexly curved shape. As used herein, “complex curve”, “complexly curved”, “complex curved substrate” and “complexly curved substrate” mean a non-planar shape having compound curves, also referred to as non-developable shapes, which include but are not limited to a spherical surface, an aspherical surface, and a toroidal surface, where the curvature of two orthogonal axes (horizontal and vertical one) are different, which can be for example a toroidal shape, an oblate spheroid, oblate ellipsoid, prolate spheroid, prolate ellipsoid, or where the surface's principle curvature along two orthogonal planes are opposite, for example a saddle shape or surface, such as a horse or monkey saddle. Other examples of a complex curves include, but are not limited to, an elliptic hyperboloid, a hyperbolic paraboloid, and a spherocylindrical surface, where the complex curves may have constant or varying radii of curvature. The complex curve may also include segments or portions of such surfaces or be comprised of a combination of such curves and surfaces. In one or more embodiments, a glass substrate may have a compound curve including a major radius and a cross curvature. The curvature of the glass substrate can be even more complex when a significant minimum radius is combined with a significant cross curvature, and/or depth of bend. Some glass substrates may also require bending along axes of bending that are not perpendicular to the longitudinal axis of the flat glass substrate.

In one or more embodiment, the glass substrate may have radii of curvature along two orthogonal axes. In various embodiments, the glass substrate can be asymmetrical. Some glass substrates may also include bending along axes that are not perpendicular to the longitudinal axis of the substrates, prior to forming (i.e., a flat surface or flat substrate).

In one or more embodiment, the radii of curvature can be less than 1000 mm, or less than 750 mm, or less than 500 mm, or less than 300 mm In various embodiments, the glass substrate is substantially free of wrinkles or optical distortions, including at the edges of the glass substrate.

In one or more embodiments, the glass substrate can be characterized as a cold-formed glass substrate. In such embodiments, the glass substrate includes first curved substrate and a substantially planar second substrate, wherein the second substrate is cold formed to the curvature of the first substrate.

As used herein, cold form includes a forming process in which the substrates and/or the glass substrate is formed at a temperature less than the softening temperature of the first and second substrates to provide a complexly curved glass substrate.

Embodiments of the cold formed glass substrate can include at least one interlayer and at least one light responsive material, as both described herein, disposed between the first and second substrate. The cold formed glass substrate can include a display unit as described herein. In one or more embodiments, the second substrate is strengthened by forming to the curvature of the first substrate. The cold-formed glass substrate can be complexly curved as described herein.

Laminates comprising a combination of one or more layers of the glass substrates described herein are also contemplated herein. Chemically-strengthened glass substrates include glass substrates which have been treated by an ion exchange strengthening process. Chemically-strengthened glass substrates typically have a coefficient of thermal expansion (CTE) ranging between about 80×10⁻⁷/° C. to about 100×10⁻⁷/° C. The glass substrate can be an aluminosilicate glass, a borosilicate glass, an aluminoborosilicate glass, or alkali-containing forms thereof. One suitable commercial embodiment of the glass substrate an aluminosilicate glass substrate. Chemically-strengthened glass can have an identifiable compressive stress layer extending through at a least a portion of the glass substrate. The compressive stress layer may have a depth of greater than 30 μm. Chemically-strengthened glass can a flexural strength value defined by ring on ring testing (ROR) >300 MPa. Chemically-strengthened glass can have a thickness between about 0.5 mm to about 5 mm, between about 1 to about 3 mm, less than 3 mm, less than 2 mm, from about 0.3 mm to about 4.0 mm, from about 0.5 to about 2 mm, or from about 0.7 mm to about 1.5 mm. The chemically-strengthened glass substrates need not be limited to any specific ion exchange process. For the sake of illustration, an example ion exchange strengthening process can be conducted at a temperature of about 390° C. to about 500° C., or about 410° C. to about 450° C. for about 5 to about 15 hours.

### Etching Suspension

In accordance with one or more embodiments, the methods described herein include applying an etching suspension to a major surface of the glass substrate. The etching suspension applied to the glass substrate to create a textured surface, includes an etching suspension formulation comprising glycerin, having a general formula of:

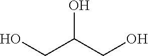

The etching suspension can be used to form a textured surface with ultra-low sparkle (e.g., a sparkle of no more than 1%).

The glycerin can be, for example, about 5 wt. % to about 30 wt. % of the etching suspension (e.g., about 10 wt. % to about 20 wt. %). The glycerin in the etching cream can, for example, lead to the ultra-low sparkle properties of the antiglare surface. The etching cream with glycerin can, for example, generate a textured surface on the substrate glass that has ultra-low sparkle property. This is due to the glycerin in etching cream impacting the kinetics of crystal mask nucleation and growth of the AG treatment (e.g., the progressing treatment of the substrate to create AG features during application of the etching cream), which can lead to uniform and small surface features distribution. Specifically, glycerin can limit the growth of a crystalline mask on the glass surface, resulting in a smaller feature size compared to etching suspensions without such a solvent. Additionally, glycerin can increase the viscosity of solution, allowing slower, uniform distribution of the etching suspension across the substrate surface, which can result in a good uniformity of texted AG surface. The unique surface feature distribution results in ultra-low sparkle properties as well as uniformity of anti-glare features across the substrate surface.

The etching suspension optionally further comprises propylene glycol (PG). For example, the etching suspension can comprise from about 1 wt. % to about 15 wt. % (e.g., about 2 wt. % to about 10 wt. %). The addition of PG can, in some instances, affect the uniformity of the etching suspension, thus requiring further mixing prior to etching.

The etching suspension can contain, for example, about 10 wt. % to about 20 wt. % NH₄F and about 0 wt. % to about 5 wt. % NH₄HF2, about 5 wt. % to about 20 wt. % KF, about 5 wt. % to about 15 wt. % FeCl₃, about 5 wt. % to about 10 wt. % KNO₃, and about 5 wt. % to about 10 wt. % BaSO₄ (a filler material). The etching suspension can alternatively contain other soluble metal salts, such CuCl₂, Fe₂(SO₄)₃, Fe(NO₃)₃, CoCl₂, Co₂SO₄, Co(NO₃)₂, NiCl₂, Ni₂SO₄, Ni(NO₃)₂, ZnCl₂, Zn2SO₄, Zn(NO₃)₂, CaCl₂, Ca₂SO₄, Ca(NO₃)₂, MgCl₂, Mg₂SO₄, Mg(NO₃)₂, which can, for example, also generate the similar ultra-low sparkle surface in combination with glycerin. Optionally, the etching suspension can contain a chelating agent.

The etching suspension can be, for example, an aqueous solution, and can be prepared by combining the appropriate soluble metal salts in water and adding in both the glycerin and an acid component (e.g., HF, HCl, or other acid as appropriate in the art for etching). Other components can be added as appropriate. The etching suspension can be further mixed prior to etching to allow homogenous application to the glass substrate during etching steps.

### Etching Process

In accordance with one or more embodiments of the method, the etching suspension is used to treat the glass substrate and create a textured surface on the glass that exhibits an ultra-low sparkle (i.e., a sparkle of no more than 1%). The etching process can be, for example, a subtractive chemical process in which the substrate glass is contacted with the etching suspension in varying times of contact to create textured features on the surface of the glass substrate. The etching process can create textured features by selectively removing material from the substrate surface to produce the textured features.

First, the substrate can optionally be cleaned, such as, for example, with a detergent or other appropriate solvent. The substrate can, for example, be rinsed with deionized (DI) water or other solvent (e.g., ethanol) after cleaning. Cleaning can allow for removal of impurities or other contaminants from the surface of the glass substrate to be etched.

Next a portion of the substrate can be laminated with a masking material so as to protect a portion or surface of the substrate glass that will not be etched. For example, one side of the glass substrate can be laminated with a masking material to allow for etching of only the opposite side of the glass substrate to create the AG feature on only one side of the substrate. Lamination can be performed, for example, with an anti-acid film, such as polyethylene or other appropriate organic film that will prevent etching on that surface by the acid and etching suspensions.

Then, the glass substrate can be contacted with a dilute acid solution, such as, for example, HCl, HF, combinations thereof, or other appropriate dilute acid solutions. The contacting can be performed by immersion, dipping, wiping, or other appropriate methods. The first contact step can be performed, for example, for about 5 seconds to about 10 seconds. Optionally, the glass substrate can be cleaned, such as, for example, by rinsing with DI or other appropriate solvent, or by wiping before and/or after the first contact. This preliminary acid contact can remove contaminations from the surface of the glass and activate the surface to allow for more uniform treatment.

Subsequently, the substrate can be etched with the etching suspension (as described above) for a first etch. Like the first acid bath, the substrate can be contacted with the etching suspension, for example, by immersion, dipping, wiping, or other appropriate methods. The contact with the etching suspension can be, for example, from about 15 seconds to about 3 minutes (e.g., about 30 seconds to about 120 seconds). After the first etching step, the glass substrate can be optionally cleaned, such as through by rinsing with DI or other appropriate solvent, or by wiping.

Because the etching suspension contains glycerin, the etching suspension can, for example, spread evenly over the substrate glass on the contact for first etch. The addition of glycerin to the etching suspension allows the kinetics of the etch to proceed quickly, as determined by the viscosity of the solution. The etching suspension can spread across the surface of the substrate glass very quickly. While not wishing to be bound by any specific theory, it is believed that this is due at least in part to the surface tension of glycerin, which is relatively high at 64.00 mN/m (20 ° C.). The high surface tension allows the etching suspension to move quickly along the substrate once exposed. Additionally, the viscosity of the etching suspension containing glycerin can be from about 20 cPs to about 500 cPs, or about 215 cPs higher than conventional etching suspensions used for AG glass substrate treatments. This prevents excessive movement of the etching suspension and falling off the substrate. The fast-moving nature of the etching suspension containing glycerin allows for quick, relatively uniform etching of the glass substrate.

An optional second etch can be performed by contacting the glass substrate with the etching suspension for a second time. For a second etch, the substrate can be cleaned (i.e., wiped or rinsed) as described above prior to the contact. The substrate can be contacted to the etching suspension by, for example, by immersion, dipping, wiping, or other appropriate methods known to one in the art. The second etch can last for, example, from about 60 seconds to about 180 seconds. The second etch can, in some embodiments, allow for polishing of the glass substrate AG features. After the second etch, the glass substrate can be optionally cleaned, such as through by rinsing with DI or other appropriate solvent, or by wiping. After the etching steps, the glass substrate can be optionally chemically strengthened, such as through ion exchange, as discussed above.

### Textured Surface

The resulting articles made by the various embodiments of the methods described herein exhibit an etched surface. The etched surface may be described as textured. Embodiments of articles with such a surface exhibits or comprises, an ultra-low sparkle of no more than 1%. The glycerin in the etching suspension creates the surface enabling the low sparkle performance, in part due to the nature of the solution moving across the substrate during the etch (as discussed above). In some embodiments, the sparkle is no more than 0.7% (e.g., no more than 0.6%). The surface area of the etched, textured surface can have, for example, a surface area that is from about 1.5 to about 50 times larger than the surface area of the starting, unetched substrate.

In various embodiments, the article can have a textured surface with a surface roughness of less than about 5μm. In some embodiments, the textured surface can have a surface roughness from about 20 nm to about 70 nm (e.g., about 30 nm to about 60 nm).

In various embodiments, due to the etching, the textured surface can have, for example, a plethora of features that are concave, allowing the dispersion effect that creates an anti-glare surface. Alternatively, the features can be, for example, convex, honey comb, bowl, or otherwise patterned .The features can be, for example, narrowly distributed along the surface of the AG glass to allow for more effective anti-glare properties. The features can substantially cover the whole surface. The concave features can be in a narrow distribution, i.e., where the percentage of features of mean size is more than 30% of the total amount of features. Here, about 41% of the total features can be in the from about 3.5 μm to about 5.5 μm (e.g., from about 4.4 μm to about 4.8 μm in size, or about 4.5 μm to about 4.7 μm).

In various embodiments, the textured surface can have a transmission haze from about 2% to about 12%. (e.g., from about 3% to about 11%). Additionally, the textured surface can have a gloss measured at 60 degrees (Gloss@60) of about 70 gloss units (GU) to about 130 GU (e.g., about 80 GU to about 120 GU). Generally, transmission haze and gloss are inversely related. The amount of time spent in each etching step can either increase gloss and decrease haze (i.e., more time polishing) or decrease gloss and increase haze (i.e., less time polishing). This inverse relationship can be used to adjust etching times and tailor the etching process depending on the end use of the AG glass substrate.

In various embodiments, the textured surface can have a DOI (distinctness of image) of less than 99.6, or preferably less than 99.4, in conjunction with a gloss of less 120.

The textured surface can have, for example, a lateral size of about 200 microns (e.g., about 100 microns). Lateral size is the measure of feature size according to roughness meter (as opposed to feature size, which can be determined by microscopy). The textured surface can have a depth of about 30 microns (e.g., about 2 microns) as defined by the arithmetical mean deviation of the roughness profile. The continuous density (i.e., the density across the whole surface of the substrate) of features on the textured surface can be, for example, about 10% to about 100%.

### Definitions

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “light” as used herein refers to electromagnetic radiation in and near wavelengths visible by the human eye and includes ultra-violet (UV) light and infrared light, from about 10 nm to about 300,000 nm wavelength.

The term “solvent” as used herein refers to a liquid that can dissolve a solid, liquid, or gas. Non-limiting examples of solvents are silicones, organic compounds, water, alcohols, ionic liquids, and supercritical fluids.

The term “room temperature” as used herein refers to a temperature of about 15° C. to 28° C.

The term “surface” as used herein refers to a boundary or side of an object, wherein the boundary or side can have any perimeter shape and can have any three-dimensional shape, including flat, curved, or angular, wherein the boundary or side can be continuous or discontinuous. While the term surface generally refers to the outermost boundary of an object with no implied depth, when the term ‘pores’ is used in reference to a surface, it refers to both the surface opening and the depth to which the pores extend beneath the surface into the substrate.

“Anti-glare” as used herein refer to a physical transformation of light contacting the treated surface of an article, such as a display, of the disclosure that changes, or to the property of changing light reflected from the surface of an article, into a diffuse reflection rather than a specular reflection. In embodiments, the surface treatment can be produced by mechanical or chemical etching. Anti-glare does not reduce the amount of light reflected from the surface, but only changes the characteristics of the reflected light. An image reflected by an anti-glare surface has no sharp boundaries. In contrast to an anti-glare surface, an anti-reflective surface is typically a thin-film coating that reduces the reflection of light from a surface via the use of refractive-index variation and, in some instances, destructive interference techniques.

“Contacting” as used herein refers to a close physical touching that can result in a physical change, a chemical change, or both, to at least one touched entity. In the present disclosure various particulate deposition or contacting techniques, such as spray coating, dip coating, and like techniques, can provide a particulated surface when contacted as illustrated and demonstrated herein. Additionally or alternatively, various chemical treatments of the particulated surface, such as spray, immersion, and like techniques, or combinations thereof, as illustrated and demonstrated herein, can provide an etched surface when contacted with one or more etchant compositions.

“Transmission haze,” or “haze,” as used herein refer to a particular surface light scatter characteristic related to surface roughness. Haze measurements can be done, for example, with an instrument such as the BYK Haze-Gard and the ASTM D1003 method. Haze measurement is specified in greater detail below.

“Roughness,” or “surface roughness (Ra),” as used herein refer to, on a microscopic level or below, an uneven or irregular surface condition. Roughness measurements can be used to determine lateral size of features, as discussed below.

“Distinctness of Image” or “DOI,” as used herein, refer to the sharpness of image, as measured with a Rhopoint IQ-S 20°/60°/85° instrument with the standard ASTM D5767 method. In accordance with method A of ASTM 5767, glass reflectance factor measurements are made on the at least one roughened surface of the glass sheet at the specular viewing angle and at an angle slightly off the specular viewing angle. The values obtained from these measurements are combined to provide a DOI value.

“Gloss,” or “gloss level,” as used herein refer to, for example, surface luster, brightness, or shine, and more particularly to the measurement of specular reflectance calibrated to a standard (such as, for example, a certified black glass standard) in accordance with ASTM procedure D523, the contents of which are incorporated herein by reference in their entirety. Common gloss measurements are typically performed at incident light angles of 20°, 60°, and 85°, with the most commonly used gloss measurement being performed at 60°. Due to the wide acceptance angle of this measurement, however, common gloss often cannot distinguish between surfaces having high and low distinctness-of-reflected-image (DOI) values. The anti-glare surface of the glass article has a gloss (i.e.; the amount of light that is reflected from sample relative to a standard at a specific angle) of up to 90 SGU (standard gloss units), as measured according to ASTM standard D523, and, in one embodiment, has a gloss in a range from about 60 SGU up to about 80 SGU. See also the DOI definition above.

“Features size,” “ALF,” or “average characteristic largest feature size” as used herein refer to a measure of surface feature variation in the x- and y-directions, i.e., in the plane of the substrate, as discussed further herein. Feature size can be determined, for example, by spectroscopy.

“Lateral size,” or “lateral feature size,” as used herein refer to a measure of lateral surface feature variation in the x- and y-directions, i.e., in the plane of the substrate, as discussed further herein. Lateral size can be determined, for example, through roughness measurements as described herein.

“Continuous density,” as used herein, refers to the density of features across the x- and y-direction, i.e., in the plane of the substrate, across the whole substrate.

“Discrete density,” as used herein, refers to the density of features across the x- and y-direction, i.e., in the plane of the substrate, for a specific portion of the substrate.

“Sparkle,” as used herein refers to the relationship between the size of features on the at least one roughened glass surface and pixel pitch, particularly the smallest pixel pitch, is of interest. Display “sparkle” is commonly evaluated by human visual inspection of a material that is placed adjacent to a pixelated display. ALF and its relationship to display “sparkle” has been found to be a valid metric for different materials having different surface morphologies, including glasses of varying composition and particle-coated polymer materials. A strong correlation between average largest characteristic feature size (ALF) and visual ranking of display sparkle severity exists across multiple different sample materials and surface morphologies. In embodiments, the glass article can be a glass panel that forms a portion of a display system. The display system can include a pixelated image display panel that is disposed adjacent to the glass panel. The smallest pixel pitch of the display panel can be greater than ALF.

“Uniformity” or “uniform” as used herein refer to the surface quality of an etched sample. Surface uniformity is commonly evaluated by human visual inspection at various angles. For example, the glass article sample is held at about eye level, and then slowly turned from 0 to 90 deg., under a standard, white fluorescent light condition. When no pin-holes, cracks, waviness, roughness, or other like defects can be detected by the observer, the surface quality is deemed “uniform”; otherwise, the sample is deemed not uniform. “Good” or “OK” ratings mean that the uniformity is acceptable or satisfactory with the former being subjectively better than the latter.

### EXAMPLES

Various embodiments of the present disclosure can be better understood by reference to the following Examples which are offered by way of illustration. The present disclosure is not limited to the Examples given herein.

Ten anti-glare glass articles (Examples 1-10) with roughened surfaces were made by an etching process where the etching suspension containing glycerin. The substrates used were aluminosilicate glass substrates from Corning that had not yet been chemically strengthened (e.g., ion exchanged).

The etching suspension contained both an etching cream (Shanghai Aladdin Bio-Chem Technology Co. LTD, China) and glycerin (Shanghai Aladdin Bio-Chem Technology Co. LTD, China), in addition to acid components and other fillers. The overall etching suspension contained 10-20 wt % NH₄F and 0-5 wt % NH₄HF, 5-20 wt % KF, 5-15 wt % FeCl₃, 5-10% KNO₃, 5-10 wt % BaSO₄ as a filler, and 5-30 wt % glycerin.

The etching suspension was prepared by weighing and mixing the solid powder chemicals (e.g., the etching cream salts). From 10 wt. % to 40 wt. % of deionized (DI) water was added and the solution was agitated. Subsequently, from about 5 wt. % to about 20 wt. % of hydrofluoric acid (40%) solution was added, and from about 5 wt. % to about 10 wt. % glycerin was mixed in slowly with manual agitation. Once all chemicals were in solution, the manual agitation was continued until a suspension formed. The etching suspension was further agitated with a mechanical agitator for about two hours or kept at ambient conditions for up to 24 hours, until chemical equilibrium was reached. The preparation of the etching suspension was done at room temperature.

Prior to etching, the glass substrate was cleaned with detergent to remove containments, followed by an ultrasonic bath with DI water. After cleaning, the glass substrate was laminated with a polyethylene film (i.e., an anti-acid film) to protect the non-etched surface of the substrate glass. After lamination, the substrate glass was immersed in a diluted HF and HCl mixed solution for a short time, about 5 to 10 seconds. Subsequently, the glass was lifted from the acid solution and rinsed in a DI water tank for about 10 seconds.

The glass substrate was then dipped into the etching suspension, in a tank, for 30 seconds to 120 seconds, as denoted below in Table 1. The glass substrate was then lifted out of the etching suspension and rinsed in the DI water tank for about 10 seconds. The glass substrate was polished in the HF and HCl solution for about 60 seconds to about 180 seconds. Then glass substrate was then rinsed and cleaning with DI. After this, the glass substrate was delaminated and air dried. The specific etching and polishing times for each of Examples 1-10 are shown below in Table 1.

TABLE 1
Etching conditions for Examples 1-10.

| | Etching time (s) | Polishing time (s) |
|---|---|---|
| Example 1 | 120 | 170 |
| Example 2 | | |
| Example 3 | 120 | 120 |
| Example 4 | | |
| Example 5 | 120 | 90 |
| Example 6 | | |
| Example 7 | 120 | 75 |
| Example 8 | | |
| Example 9 | 120 | 60 |
| Example 10 | | |

Optical properties of Examples 1-10 were measured with Rhopoint gloss meter (Rhopoint Instruments Ltd., St. Leonards, UK) and BYK Haze meter (BYK Additives & Instruments, Wesel, Germany). Sparkle was measured by SMS-1000 bench model (Display-Messtechnik & Syseme, Karlsruhe, Germany) with a pixels per inch (PPI) of 140. Roughness of the textured surfaces was measured by Mitutoyo SJ-310 roughness meter (Mitutoyo U.S.A., Aurora, Ill.). The optical and surface properties of Examples 1-10 are summarized in Table 2 below.

Gloss at 60 degrees and DOI were measured with a Rhopoint gloss meter using standard measurement methodology. Gloss was measured proportional to the amount of light reflected from a surface. Measurement geometry was chosen based on the reflectance of the material at Mid Gloss 60° in gloss units (GU). DOI was measured based on how clearly a reflected image would appear in a reflective surface. Symptoms of Poor DOI included Orange peel, brush marks, waviness or other structures visible on the surface, or where reflected images were distorted. Poor DOI can be caused correlating to surface features. DOI was measured on the DOI measurement scale of 0-100, where 100 is a smooth surface.

Haze, transmittance, and transmission haze were measured with a BYK Haze-Guard and the ASTM D1003 hazemeter (Procedure A) standard method. Light that is scattered upon passing through a film or sheet of a material can produce a hazy or smoky field when objects are viewed through the material. The method used light scattering of the sample to quantify transmission haze, transmittance, and transmission haze.

Specifically, in the ASTM D1003 Procedure A, a collimated beam of light from a light source was passed through the sample mounted on the entrance port of an integrating sphere in the instrument. The light, which was uniformly distributed by a matte white highly reflective coating on the sphere walls, was measured by a photodetector positioned at 90° from the entrance port. A baffle mounted between the photodetector and the entrance port prevented direct exposure from the port. The exit port immediately opposite the entrance port contained a light trap to absorb all light from the light source when no sample is present. A shutter in this exit port coated with the same coating as the sphere walls allowed the port to be opened and closed as required. Total transmittance was measured with the exit port closed. Transmittance haze was measured with the exit port open.

Sparkle was measured with an SMS-1000 bench instrument. With this instrument, sparkle was be measured by applying a scattering anti-glare layer (glass or polymer film) to a display screen with a specific pitch of the pixel matrix and an image of that combination was taken with the camera of the SMS1000. The recorded image was numerically low-pass filtered to account for the limited angular resolution of the human eye and to separate the display pixel modulation from the sparkle. When the antiglare layer was not fixed to the display pixel matrix, a difference image was created from two camera exposures with a slightly translated anti-glare layer prior to application of spatial filtering. The level of sparkle was evaluated as the standard deviation of the gray-level distribution of the filtered image divided by the mean value.

TABLE 2
Anti-glare properties of ultra-low sparkle textured Examples 1-12
fabricated by etching cream process added with organic solvent glycerin.

| | | | Trans- | | | | | Mean |
|---|---|---|---|---|---|---|---|---|
| | Level of | Trans- | mission | | | | Feature | Surface |
| | transmission | mittance | haze | Gloss | | Sparkle | size | Roughness |
| | haze (%) | (%) | (%) | @60° | DOI | <1% | (μm) | (Ra, nm) |
| Exp. 1 | 2-3 | 93.9 | 2.09 | 132.47 | 99.6 | 0.49 | 5.02 | 22 |
| Exp. 2 | | 93.9 | 2.25 | 130.05 | 99.5 | 0.51 | 4.98 | 28 |
| Exp. 3 | 3-4 | 93.9 | 3.67 | 119.3 | 99.4 | 0.7 | 4.77 | 37 |
| Exp. 4 | | 93.9 | 3.71 | 119.3 | 99.4 | 0.69 | 4.8 | 36 |
| Exp. 5 | 5-6 | 93.9 | 5.58 | 116.66 | 99.4 | 0.6 | 4.71 | 42 |
| Exp. 6 | | 93.9 | 5.54 | 116.81 | 99.4 | 0.65 | 4.69 | 46 |
| Exp. 7 | 8-9 | 93.9 | 8.32 | 103.24 | 99.3 | 0.77 | 4.68 | 56 |
| Exp. 8 | | 93.9 | 8.28 | 104.72 | 99.3 | 0.76 | 4.7 | 55 |
| Exp. 9 | 11-12 | 93.8 | 11.1 | 86.69 | 99.3 | 0.88 | 4.37 | 57 |
| Exp. 10 | | 93.8 | 11.6 | 87.44 | 99.3 | 0.9 | 4.45 | 61 |

Examples 1-10 show ultra-low sparkle values at<1% while keeping the appropriate anti-glare effect (e.g., transmission haze of about 2% to about 12%). The optical properties of Examples 1-10 also indicate that the etching suspension including glycerin allows for a wide range of optical properties when applied to substrate glass with varying etching and polishing times. The anti-glare effect of the substrate can, for example, be tailored depending on specific anti-glare needs while maintaining a low sparkle of less than 1% by adjusting the polishing time of the glass substrate as shown in Table 2.

The surface morphology of Examples 1-10 was tested with Nikon Eclipse L200N (Nikon Metrology, Brighton, MI). In general, the adjustment of polishing time from 60 seconds to 120 seconds, affected the surface morphology of the Examples 1-10. Adjusting polishing time effected the transmission haze of the Examples. For instance, transmission haze varied from 11.1% to 2.09% when the polishing time was gradually increased from 60 seconds to 170 seconds. This also affected the feature size of the surface of the Examples 1-10, which varied from about 4 μm to about 5 μm, determined by the longest dimension along the x-y plan. Feature size was determined by spectroscopy (as opposed to lateral size, which can be determined by roughness measurements).

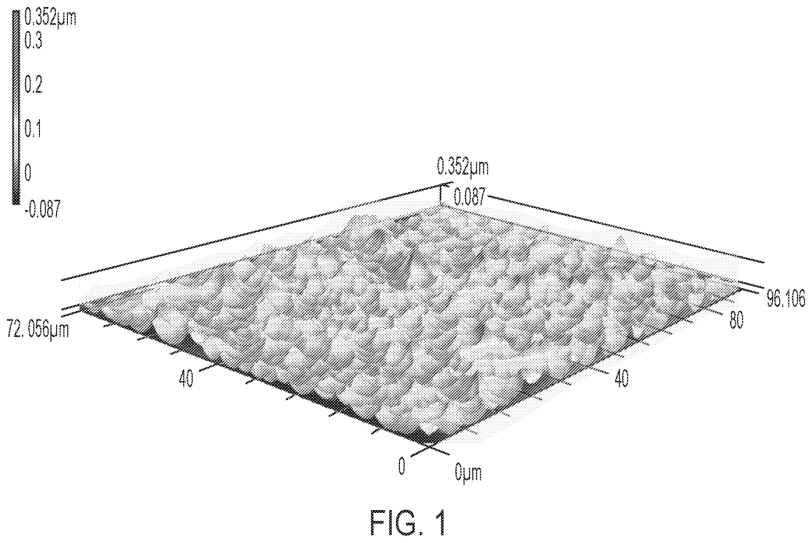

FIG. 1 shows the topography of the textured surface of Example 6 made on an aluminosilicate glass substrate. The topography was mapped by Keyence Confocal Laser Scanning Microscopy (KEYENCE America, Itasca, Ill.). There were many small protrusions on the glass surface, which can, for example, improve touch feeling compared to bare glass. The average roughness of the textured glass surface of glass is shown below in Table 3. Shown are arithmetical mean deviation of the roughness profile (Ra), maximum height of the roughness profile (Rz), mean width of the roughness profile elements (RSm), maximum profile peak height of the roughness profile (Rp), maximum profile valley depth of the roughness profile (Rv), mean height of the roughness profile elements (Rc), total height of the roughness profile (Rt), root mean square deviation of the roughness profile (Rq), skewness of the roughness profile (Rsk) and kurtosis of the roughness profile (Rku).

TABLE 3
Roughness measurements of Example 6 shown in μm.

| | Ra | Rz | RSm | Rp | Rv | Rc | Rt | Rq | Rsk | Rku |
|---|---|---|---|---|---|---|---|---|---|---|
| Avg. | 0.038 | 0.221 | 10.229 | 0.166 | 0.055 | 0.139 | 0.221 | 0.049 | 1.409 | 4.185 |
| Max | 0.043 | 0.26 | 13.528 | 0.194 | 0.066 | 0.169 | 0.26 | 0.054 | 1.624 | 4.698 |
| Min | 0.032 | 0.183 | 6.93 | 0.139 | 0.044 | 0.109 | 0.183 | 0.043 | 1.194 | 3.673 |

The Ra (arithmetical mean deviation of the roughness profile) was around 0.04m and could be varied from 0.02 μm to 0.07 μm with different haze levels. Additionally, Rsk and Rku, which describe the sharpness of textured surface, were varied from 1˜3 and 3˜8, respectively. For example, the Rsk and Rku are 1.4 and 4.2 in this Example.

The Examples 1-10 overall showed the appearance of a substantially uniform anti-glare (AG) coating. For instance, Example 6 was a textured surface on an aluminosilicate glass having a composition including about 64 mol % SiO₂, 16 mol % Al₂O₃, 11 mol % Na2O, 6 mol % Li2O, 1 mol % ZnO, and 2.5 mol % P2O5. The Example 6 sample size was 2″×2″. As shown in Table 2, Example 6 had a transmission haze of 5.5%, a gloss@60 degrees of 116.7, a distinctness of image (DOI) of 99.4 and a sparkle of 0.65., with a feature size of 4.7 μm. Upon visual inspection, Example 6 had a slight scattering to ambient light, and an image kept clarity viewing through the transmission of the sample. Thus, the ultra-low sparkle textured glass, such as Example 6, should provide an AG effect and show a clear image simultaneously.

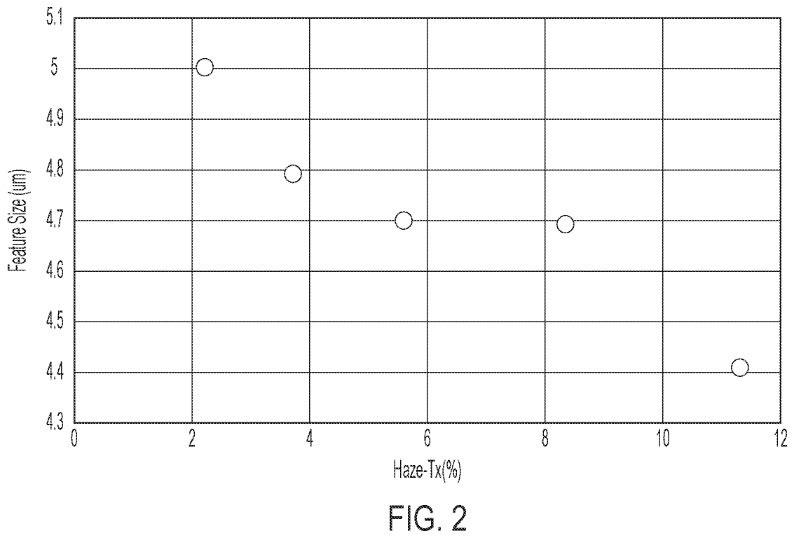

FIG. 2. illustrates a graphical representation of a correlation of transmission haze and feature size for Examples 1-10, in accordance with various embodiments. Here, the transmission Haze decreased gradually while the feature size increased. This likely resulted from longer polishing times that increased feature size.

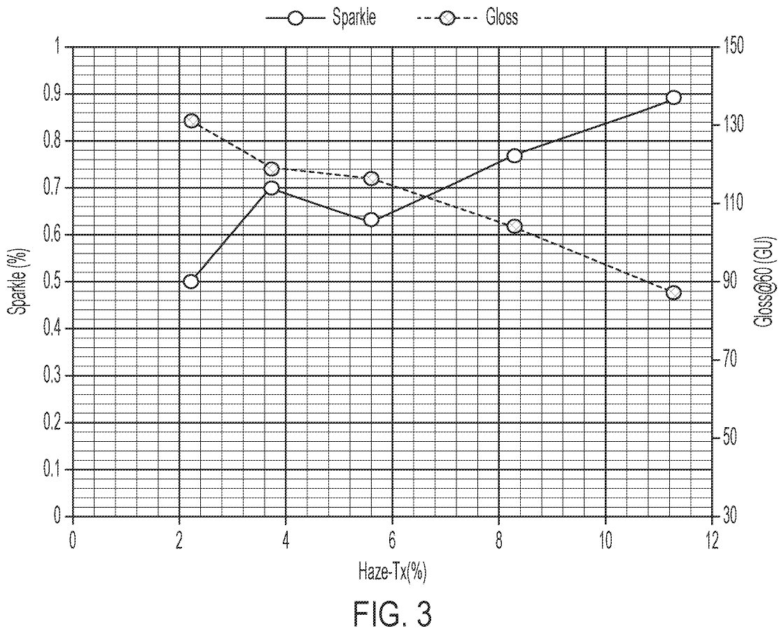

FIG. 3. illustrates a graphical representation of a relationship among transmission haze, sparkle and Gloss@60 degree for Examples 1-10, in accordance with various embodiments. There was a positive correlation between the transmission haze and sparkle (within the range of less than 1%), and an inverse relationship observed between gloss and haze as expected.

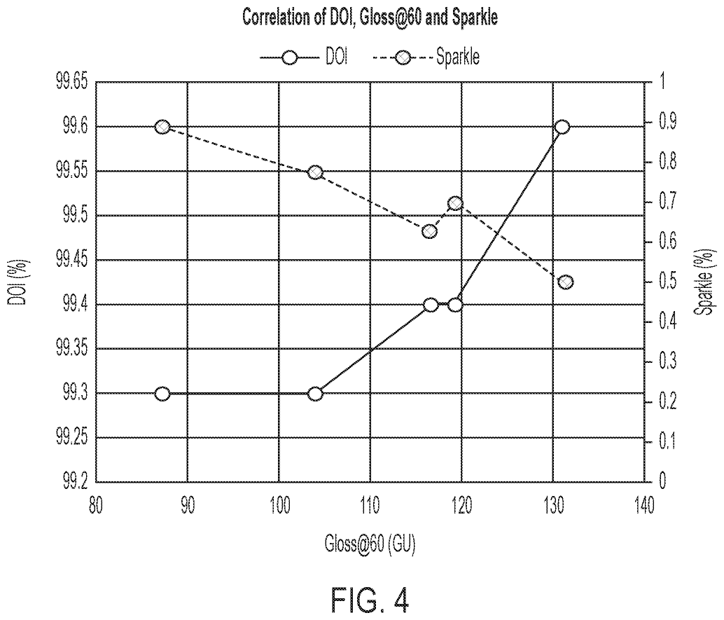

FIG. 4. illustrates a graphical representation of a correlation of Gloss@60 degree, DOI and Sparkle for Examples 1-10, in accordance with various embodiments. FIG. 4 shows a correlation of Gloss@60 degree, DOI and sparkle for Examples 1-10. Based on the measured results Example 1-10 (see Table 2), DOI was be between 99.3 and 99.4 when Gloss@60 degree was lower than 120. Normally, a lower gloss can produce stronger anti-glare effects, while sparkle would increase and DOI decrease. For this reason, with ultra-low sparkle of <1%, the Gloss@60 degree and DOI were preferably kept low. In Examples 1-10, DOI was less than about 99.4 when Gloss@60 degree was from about 80 GU to about 120 GU.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 includes a method of making an article including etching a surface of a substrate with an etching suspension comprising an etching cream and glycerin, wherein the article comprises a sparkle of no more than 1%.

Embodiment 2 includes Embodiments 1, wherein the etching suspension comprises from about 5 wt % to about 30 wt % glycerin.

Embodiment 3 includes any of the Embodiments 1-2, wherein the etching cream comprises one or more salts selected from the group consisting of NH4F, NH4HF2, KF, FeCl3, KNO3, BaSO₄, CuCl2, Fe2(SO4)3, Fe(NO3)3, CoCl2, Co2SO4, Co(NO3)2, NiCl2, Ni2SO4, Ni(NO3)2, ZnCl2, Zn2SO4, Zn(NO3)2, CaCl2, Ca2SO₄, Ca(NO3)2, MgCl2, Mg2SO4, Mg(NO3)2, and combinations thereof.

Embodiment 4 includes any of the Embodiments 1-3, wherein the etching cream comprises from about 10 wt % to about 20 wt % NH4F.

Embodiment 5 includes any of the Embodiments 1-₄, wherein the etching cream comprises from about 0 wt % to about 5 wt % NH4HF2.

Embodiment 6 includes any of the Embodiments 1-5, wherein the etching cream comprises from about 5 wt % to about 20 wt % KF.

Embodiment 7 includes any of the Embodiments 1-6, wherein the etching cream comprises from about 5 wt % to about 15 wt % FeCl3.

Embodiment 8 includes any of the Embodiments 1-7, wherein the etching cream comprises from about 5 wt % to about 10 wt % KNO3.

Embodiment 9 includes any of the Embodiments 1-8, wherein the etching cream comprise from about 5 wt % to about 10 wt % BaSO4.

Embodiment 10 includes any of the Embodiments 1-9, further comprising preparing the etching cream by mixing the one or more salts with the glycerin.

Embodiment 11 includes any of the Embodiments 1-10, further comprising cleaning the substrate prior to etching.

Embodiment 12 includes any of the Embodiments 1-11, further comprising laminating the substrate prior to etching.

Embodiment 13 includes any of the Embodiments 1-12, further comprising delaminating the substrate after etching.

Embodiment 14 includes any of the Embodiments 1-13, wherein etching comprises at least two etching steps.

Embodiment 15 includes any of the Embodiments 1-14, wherein etching comprises: contacting the substrate with a dilute acid solution, and optionally rinsing the substrate, contacting the substrate with the etching suspension for a first etch, and optionally rinsing the substrate, and optionally contacting the substrate with the etching suspension for a second etch, and optionally rinsing the substrate.

Embodiment 16 includes any of the Embodiments 1-15, wherein contacting the substrate with a dilute acid solution is done for about 5 seconds to about 10 seconds.

Embodiment 17 includes any of the Embodiments 1-16, wherein contacting the substrate with the etching suspension is done for about 30 seconds to about 120 seconds.

Embodiment 18 includes any of the Embodiments 1-17, wherein contacting the substrate with the etching suspension is done for about 60 seconds to about 180 seconds.

Embodiment 19 includes any of the Embodiments 1-18, further comprising cleaning the substrate after etching.

Embodiment 20 includes any of the Embodiments 1-19, further comprising chemically strengthening the substrate.

Embodiment 21 includes any of the Embodiments 1-20, wherein chemically strengthening the substrate comprises ion exchanging the substrate.

Embodiment 22 includes an article comprising a substrate having a textured surface and comprising a sparkle of no more than 1%.

Embodiment 23 includes Embodiments 22, wherein the sparkle is no more than 0.7%.

Embodiment 24 includes any of the Embodiments 22-23, wherein the sparkle is no more than 0.6%.

Embodiment 25 includes any of the Embodiments 22-24, wherein the substrate is a chemically strengthened glass.

Embodiment 26 includes any of the Embodiments 22-25, wherein the textured surface has a surface roughness of less than 5 μm.

Embodiment 27 includes any of the Embodiments 22-26, wherein the textured surface has a roughness from about 20 nm to about 70 nm.

Embodiment 28 includes any of the Embodiments 22-27, wherein the textured surface has a roughness from about 30 nm to about 60 nm.

Embodiment 29 includes any of the Embodiments 22-28, wherein the textured surface comprises concave, convex, honey comb, bowl, or patterned features.

Embodiment 30 includes any of the Embodiments 22-29, wherein the concave features are narrowly distributed and fully cover the textured surface.

Embodiment 31 includes any of the Embodiments 22-30, wherein the concave features comprise a size from about 4 μm to about 5 μm.

Embodiment 32 includes any of the Embodiments 22-31, wherein the concave features comprise a size from about 4.4 μm to about 4.8 μm.

Embodiment 33 includes any of the Embodiments 22-32, wherein the textured surface has a transmission haze from about 2% to about 12%.

Embodiment 34 includes any of the Embodiments 22-33, wherein textured surface has a gloss at 60 degrees of from about 70 GU to about 130 GU.

Embodiment 35 includes any of the Embodiments 22-34, wherein the textured surface has a gloss at 60 degrees of from about 80 GU to about 120 GU.

Embodiment 36 includes any of the Embodiments 22-35, wherein the textured surface has a distinctness of image (DOI) of less than about 99.6.

Embodiment 37 includes any of the Embodiments 22-36, wherein the textured surface has a DOI of less than about 99.4.

Embodiment 38 includes any of the Embodiments 22-37, wherein the textured surface has a lateral size of about 200 microns.

Embodiment 39 includes any of the Embodiments 22-38, wherein the textured surface has a lateral size of about 100 microns.

Embodiment 40 includes any of the Embodiments 22-39, wherein the textured surface has a depth of about 30 microns as defined by the arithmetical mean deviation of the roughness profile.

Embodiment 41 includes any of the Embodiments 22-40, wherein the textured surface has a depth of about 2 microns as defined by the arithmetical mean deviation of the roughness profile.

Embodiment 42 includes any of the Embodiments 22-41, wherein the continuous density of features on the textured surface is about 10% to about 100%.

1. A method of making an article comprising:
etching a surface of a substrate with an etching suspension comprising an etching cream and glycerin, wherein the article comprises a sparkle of no more than 1%.

2. The method of claim 1, wherein the etching suspension comprises from about 5 wt % to about 30 wt % glycerin.

3. The method of claim 1, wherein the etching cream comprises one or more salts selected from the group consisting of NH₄F, NH₄HF₂, KF, FeCl₃, KNO₃, BaSO₄, CuCl₂, Fe₂(SO₄)₃, Fe(NO₃)₃, CoCl₂, Co₂SO₄, Co(NO₃)₂, NiCl₂, Ni₂SO₄, Ni(NO₃)₂, ZnCl₂, Zn₂SO₄, Zn(NO₃)₂, CaCl₂, Ca₂SO₄, Ca(NO₃)₂, MgCl₂, Mg₂SO₄, Mg(NO₃)₂, and combinations thereof.

4. The method of claim 3, wherein the etching cream comprises from about 10 wt % to about 20 wt % NH₄F.

5. The method of claim 3, wherein the etching cream comprises at least one of:
from about 0 wt % to about 5 wt % NH₄HF₂,
from about 5 wt % to about 20 wt % KF,
from about 5 wt % to about 15 wt % FeCl₃,
from about 5 wt % to about 10 wt % KNO₃, and
from about 5 wt % to about 10 wt % BaSO₄.

6. (canceled)

7. (canceled)

8. (canceled) 9. (canceled)

10. The method of claim 3, further comprising preparing the etching cream by mixing the one or more salts with the glycerin.

11. (canceled)

12. (canceled)

13. (canceled)

14. (canceled)

15. The method of any one of the preceding claims, wherein etching comprises:
contacting the substrate with a dilute acid solution, and optionally rinsing the substrate;
contacting the substrate with the etching suspension for a first etch, and optionally rinsing the substrate; and
optionally contacting the substrate with the etching suspension for a second etch, and
optionally rinsing the substrate.

16. The method of claim 15, wherein:
contacting the substrate with a dilute acid solution is done for about 5 seconds to about 10 seconds,
contacting the substrate with the etching suspension is done for about 30 seconds to about 120 seconds, and
contacting the substrate with the etching suspension is done for about 60 seconds to about 180 seconds.

17. (canceled)

18. (canceled)

19. (Cancelled)

20. The method of claim 1, further comprising chemically strengthening the substrate.

21. (canceled)

22. An article comprising:
a substrate having a textured surface and comprising a sparkle of no more than 1%.

23. (canceled)

24. (canceled)

25. (canceled)

26. (canceled)

27. The article of claim 22, wherein the textured surface has a roughness from about 20 nm to about 70 nm.

28. (canceled)

29. The article of claim 27, wherein the textured surface comprises concave, convex, honey comb, bowl, or patterned features.

30. The article of claim 29, wherein the concave features are narrowly distributed and fully cover the textured surface.

31. The article of claim 29, wherein the concave features comprise a size from about 4 μm to about 5 μm.

32. (canceled)

33. The article of claim 22 of any one of claims 22 32, wherein the textured surface has a transmission haze from about 2% to about 12%.

34. The article of claim 22 of any one of claims 22 33, wherein textured surface has a gloss at 60 degrees of from about 70 GU to about 130 GU.

35. (canceled)

36. The article of claim 22 any one of claims 22 35, wherein the textured surface has a distinctness of image (DOI) of less than about 99.6.

37. (canceled)

38. The article of claim 22 any one of claims 22 37, wherein the textured surface has a lateral size of about 200 microns.

39. (canceled)

40. The article of claim 22, wherein the textured surface has a depth of about 30 microns as defined by the arithmetical mean deviation of the roughness profile.

41. (canceled)

42. The article of claim 22, wherein the continuous density of features on the textured surface is about 10% to about 100%.
